(19) United States
(12) Patent Application Publication
(10) Pub. No.: US 2016/0328086 A1
(43) Pub. Date: Nov. 10, 2016

(54) METHOD FOR OPERATING COMPLEX PANEL AND ELECTRONIC DEVICE THEREFOR

(71) Applicant: SAMSUNG ELECTRONICS CO., LTD., Suwon-si, Gyeonggi-do (KR)

(72) Inventors: One-Gun LEE, Seoul (KR); Chang-Jae JANG, Suwon-si (KR); Jin-Ho CHO, Hwaseong-si (KR); Kwon-Soo KIM, Suwon-si (KR); Moo-Young KIM, Seoul (KR); Ju-Pyo HONG, Suwon-si (KR)

(21) Appl. No.: 15/109,737

(22) PCT Filed: Dec. 11, 2014
(86) PCT No.: PCT/KR2014/012196

§ 371 Date: Jul. 5, 2016

(30) Foreign Application Priority Data
Jan. 6, 2014 (KR) 10-2014-0001540

(51) Int. Cl. G06F 3/041; G06F 3/046; G06F 3/043; G06F 3/042; G06F 3/044; G06F 3/045

(52) U.S. Cl. CPC G06F 3/0418; G06F 3/0412; G06F 3/044; G06F 3/045; G06F 3/043; G06F 3/0421; G06F 3/046; G06F 2203/04108

(57) ABSTRACT

Various embodiments of the present invention relate to a method for operating a complex panel, including a display panel and at least one sensing panel, and provided are the method for operating a complex panel and an electronic device therefor, the method comprising: identifying a scanning period of the display panel; and calibrating the sensing panel by using first location calibration information when the identified scanning period belongs to a first range, and calibrating the sensing panel by using second location calibration information when the scanning period belongs to a second range. Therefore, a location can be smoothly detected by enabling an adaptive variance so as to optimize object detection conditions of at least one sensing panel included together according to an operation environment of the display panel, and ensuring the reliability of the electronic device.

### TECHNICAL FIELD

Various embodiments of the present invention relate to a method for operating complex panel and an electronic device therefor.

### BACKGROUND ART

Generally, various electronic devices include input devices for inputting data and output devices for outputting data. The input devices may include not only at least one physical key button disposed in a proper position of an electronic device, but also a panel for receiving input data in the same area as a display used as an output device in various sensing schemes.

According to an embodiment, such a panel may include a panel of a direct touch scheme for acquiring an input which directly touches a display area, or a panel of an indirect touch scheme (hovering input scheme) for sensing that an approaching object (e.g., person's finger, electronic pen) has entered within a predetermined sensing distance, even when the display area is not touched, thereby recognizing the location of the object.

According to an embodiment, an electromagnetic inductive scheme may be used as one indirect touch scheme which uses a separate object. An electronic device includes, as a sensing means, a magnetic inductive panel (in general, referred to as “digitizer flat sheet”) in which multiple coils are arranged orthogonal to each other, and a resonance circuit may be included in a pen type object. Therefore an AC signal is applied to a coil array of the magnetic inductive panel to operate the coil array; when an object becomes adjacent to a display of the electronic device, a coil of the magnetic inductive panel, adjacent to the object, forms a magnetic field; resonance is made with the magnetic field and a resonance frequency is generated in the object; the generated resonance frequency is sensed in a magnetic inductive driver IC for a magnetic inductive panel of the electronic device; and thereby the corresponding touch location may be determined.

Meanwhile, even when the above-described magnetic inductive panel is included and a data input by a direct or indirect touch is performed, the present invention may be implemented as a plurality of panels by further including at least one sensing panel which is used in inputting data by a direct touch with a display.

### DETAILED DESCRIPTION OF THE INVENTION

### Technical Problem

Various embodiments of the present invention may include a method for operating a complex panel and an electronic device therefor.

Various embodiments of the present invention may include a method for operating a complex panel and an electronic device therefor, wherein an object detection condition can be adaptively changed according to an operation environment of a display.

Various embodiments of the present invention may include a method for operating a complex panel and an electronic device therefor, which are implemented to exclude, in advance, a mutual interference between complex panels so as to contribute to the implementation of smooth performance.

Various embodiments of the present invention may include a method for operating a complex panel and an electronic device therefor, which are implemented to induce an data input to be precisely performed, thereby contributing to ensuring the reliability of an electronic device.

### Technical Solution

According to various embodiments of the present invention, it may be possible to provide a method for operating a complex panel a display panel and at least one sensing panel, the method comprising: identifying a scanning period of the display panel; and calibrating the sensing panel by using first location calibration information when the identified scanning period belongs to a first range, and calibrating the sensing panel by using second location calibration information when the scanning period belongs to a second range.

### Advantageous Effects

According to various embodiments of the present invention, an electronic device can detect a location of an object by adaptively varying an object detection (e.g., user input) condition of at least one sensing panel included together according to an operation environment of an LCD panel

### BRIEF DESCRIPTION OF THE DRAWINGS

FIG. 1 is a perspective view illustrating a use state of an electronic device according to various embodiments of the present invention.

FIG. 2 is a sectional view of an important part of an electronic device having a complex panel applied thereto according to an embodiment of the present invention.

FIG. 3 is a configuration view illustrating a relationship of an input location which is input in a complex panel according to an embodiment of the present invention.

FIG. 4 is a block diagram of an electronic device according to an embodiment of the present invention.

FIG. 5 is a configuration view of a display panel and a magnetic inductive panel according to an embodiment of the present invention.

FIGS. 6 and 7 are flowcharts illustrating a process for calibrating a location of a magnetic inductive panel on the basis of an operation condition of a display panel according to various embodiments of the present invention.

FIG. 8 is a graph illustrating a correlation with a scanning period of a display panel according to a noise applied to a magnetic inductive panel according to an embodiment of the present invention.

FIGS. 9 and 10 are flowcharts illustrating a process for changing an internal operation clock of a display panel on the basis of an operation condition of the display panel according to various embodiments of the present invention.

### MODE FOR CARRYING OUT THE INVENTION

Hereinafter, various embodiments of the present invention will be described with reference to the accompanying drawings. Further, in the following description of the present invention, a detailed description of known functions and configurations incorporated herein will be omitted when it may make the subject matter of the present invention rather unclear. The terms which will be described below are terms defined in consideration of the functions in the present invention, and may be different according to users, intentions of the users, or customs. Therefore, the definitions of the terms should be made based on the contents throughout the specification.

According to various embodiments of the present invention, a display module may be referred to as a display, and may include a panel for merely outputting input data, for example, a liquid crystal display (LCD) panel, a panel using an organic light emitting diodes (OLED), an active matrix OLED (AMOLED) panel, or a panel formed of low-temperature crystalline silicon. According to an embodiment, the display module may be a hard type panel and may be a flexible panel. According to an embodiment, the display module may be a glass substrate and may be a film substrate made of a synthetic resin material. According to various embodiments, the display module is not limited to the above described panels or substrates.

According to various embodiments of the present invention, a touch screen device may be conceptually include at least one sensing panel for a data input, which is arranged in a laminated structure together with the display module. For example, the touch screen device may be the display module and a sensing panel for sensing an input object, the panel being arranged at the upper or lower parts of the display module.

According to various embodiments of the present invention, an electronic device may be applied to various electronic devices which may include the display module and at least one above-described sensing panel for sensing an object, which is applied together with the same, for example, a personal digital assistant (PDA), a laptop computer, a mobile phone, a smart phone, a netbook, a mobile Internet device (MID), a ultra mobile PC (UMPC), a tablet personal computer (tablet PC), and a navigation, MP3, a wearable electronic device.

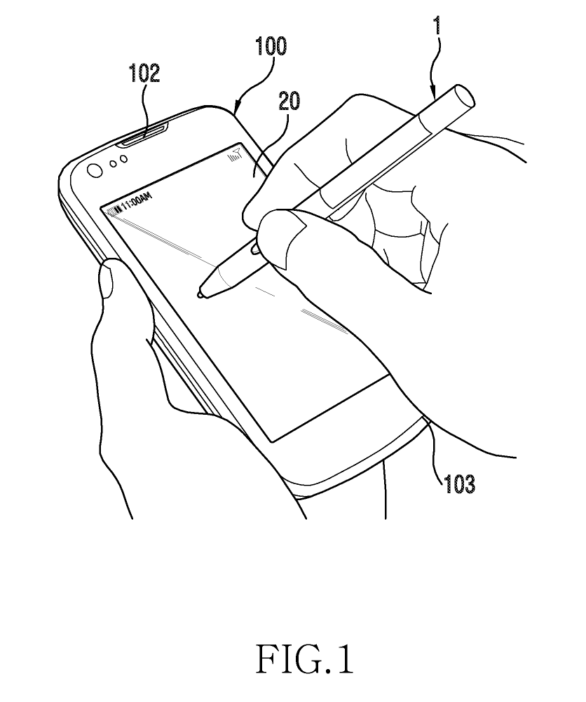

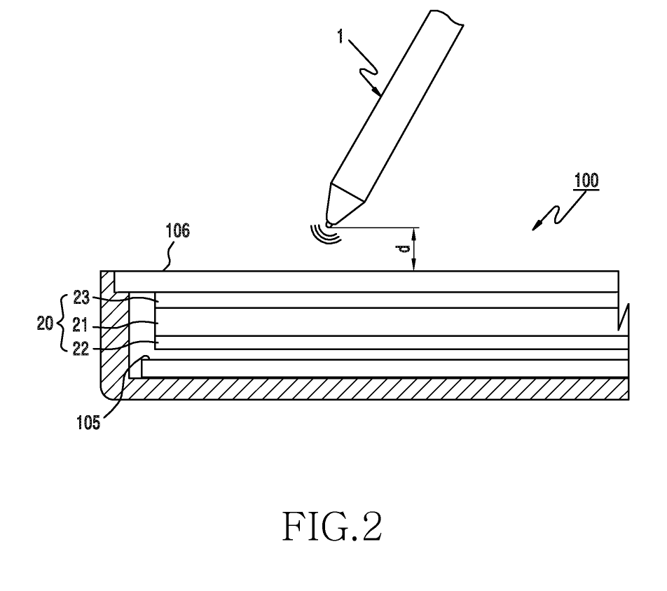

FIG. 1 is a perspective view illustrating a use state of an electronic device according to various embodiments of the present invention. FIG. 2 is a sectional view of an important part of an electronic device having a complex panel applied thereto according to an embodiment of the present invention.

Referring to FIG. 1, an electronic device 100 may include a plurality of panels 20. According to an embodiment, the plurality of panels 20 may be, for example, “a touch screen device” which can perform an input and output of data.

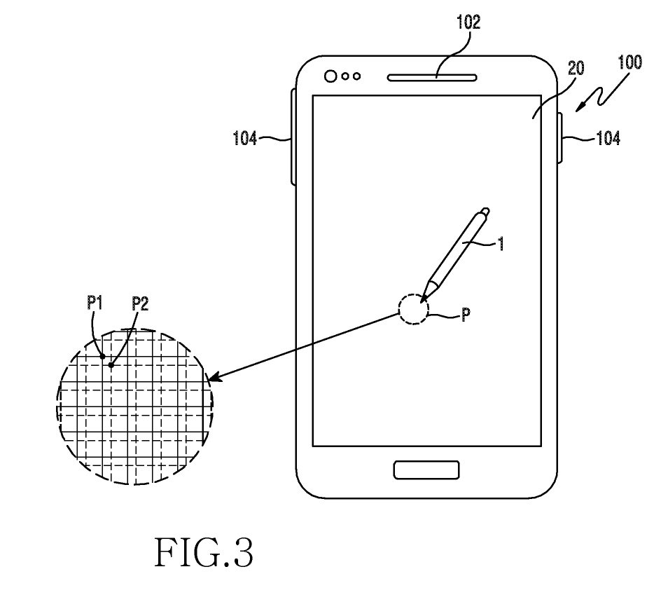

According to an embodiment, the complex panel 20 may include a display panel (e.g.: LCD panel) which corresponds to a data output module. According to an embodiment, the complex panel 20 may be included in an arrangement area overlapped with, for example, the LCD panel which corresponds to a data input module or may be arranged in an area proximate thereto; and may include at least one sensing panel for sensing an object (e.g., a person's finger or an electronic pen 1 for a data input) used as a data input means. According to an embodiment, the complex panel 20 may include at least one key button (104 in FIG. 3) which corresponds to a data input module (user input module) and is arranged at the outside of the electronic device 100.

According to various embodiments, the sensing panel may detect an input based on a direct touch of the object; may detect an input from when the object enters within the predetermined sensing distance without touching the complex panel 20; or may detect an input in the above-described both cases. According to various embodiments, the sensing panel may be, for example, at least one of a capacitive type panel, a resistive type panel, a (ultra)sonic type panel, an optical (infrared) sensor type panel and electromagnetic induction type panel.

According to an embodiment of the present invention, a description has been made on the complex panel 20 in which a capacitive type touch panel for receiving a data input by a direct touch or a magnetic inductive panel for receiving a data input by an indirect touch of an electronic pen is implemented together with an LCD panel. However, the complex panel is not limited thereto.

Referring to FIG. 2, the complex panel 20 may be arranged such that at least a part of the complex panel overlaps. For example, when the complex panel 20 includes a display panel 21 and a sensing panel (a touch panel 23 or a magnetic inductive panel 22), the display panel 21 may be placed on the sensing panel while at least a part of the display panel 21 overlaps with the sensing panel.

According to an embodiment, the electronic device 100 may include the above-described complex panel 20. According to an embodiment, the complex panel 20 may include the magnetic inductive panel 22, the display panel 21, and the touch panel 23. For the convenience of a description, it has been described that the complex panel 20 is configured to include the magnetic inductive panel 22, the display panel 21, and the touch panel 23, but the configuration is not limited thereto. For example, the complex panel 20 may include the display panel 21 and the magnetic inductive panel 22. According to an embodiment, the touch panel 23, which is made of a transparent material, may also be mounted, for example, on one side of a window 106 of the electronic device 100 in such a scheme as a deposition. Further, for example, the touch panel 23 may also be mounted on the LCD panel 21, and may also be separately mounted.

According to an embodiment, although the magnetic inductive panel 22 is not illustrated, it may include, for example, a sensor printed circuit board (sensor PCB), on which a plurality of X axis coil arrays and a plurality of Y axis coil arrays are arranged orthogonally to each other, a shield plate arranged beneath the sensor PCB, and a connector electrically connected to a circuit 105 of the electronic device 100 (e.g. PCB). According to an embodiment, since the magnetic inductive panel 22 includes, for example, a coil having light-shielding properties, it is desirable that the magnetic inductive panel 22 is placed below a separate touch panel 23 and a separate LCD panel. However, the configuration is not limited thereto, and the arrangement of the touch panel 23, the LCD panel 21, and the magnetic inductive panel 22 may be changed.

According to an embodiment, when an electronic pen 1, which is used as an object for a data input, approaches within a predetermined distance d (e.g.: 2 cm) from a window 106 of the electronic device 100, the magnetic inductive panel 22 may sense the electronic pen 1. In this case, the electronic device 100 may detect, separately from the touch panel 23, a location of the electronic pen 1 and then perform a function (e.g.: icon selection function) corresponding to the location.

According to various embodiments of the present invention, the display panel 21 and magnetic inductive panel 22 of the complex panel 20 may be positioned proximate to each other. For example, when the display panel 21 operates in a command (cmd) mode, the scanning period of the display panel 21 may be changed on the basis of a change in a state (e.g: temperature, humidity, brightness, shape, or voltage) of the LCD panel 21. The input location of an object (e.g.: user input), which is recognized by the magnetic inductive panel 22, may varies on the basis of a signal (or noise) generated according to the changed scanning period.

FIG. 3 is a configuration view illustrating a relationship of an input location which is input in a complex panel according to an embodiment of the present invention.

Referring to FIG. 3, for example, when the electronic pen 1 indicates an illustrated input location P on the complex panel 20, a precise input point may be P1. However, the magnetic inductive panel 22 may be affected by a signal (e.g.: noise) generated by a scanning period changed according to a change in the temperature of the display panel 21, and may thus recognize the location of the electronic pen 1 as the input location of an illustrated P2. Moreover, Owing to an influence of a signal (e.g.: noise) generated from the display panel 21, the magnetic inductive panel 22 may perform an operation for sensing an input of the electronic pen 1 even in a situation where there is no input operation of the electronic pen 1.

According to various embodiments of the present invention, the electronic device 100 may control, by using, for example, a magnetic inductive driver IC, the magnetic inductive panel 22 to detect a scanning period of the display panel 21 and to calibrate the detected location of the magnetic inductive panel 22. According to an embodiment, when the detected scanning period of the display panel 21 does not exist within a predetermined threshold range, the electronic device 100 may also change, for example, an internal operation clock of the display panel 21, thereby changing the scanning period of the display panel 21 to a desirable interval.

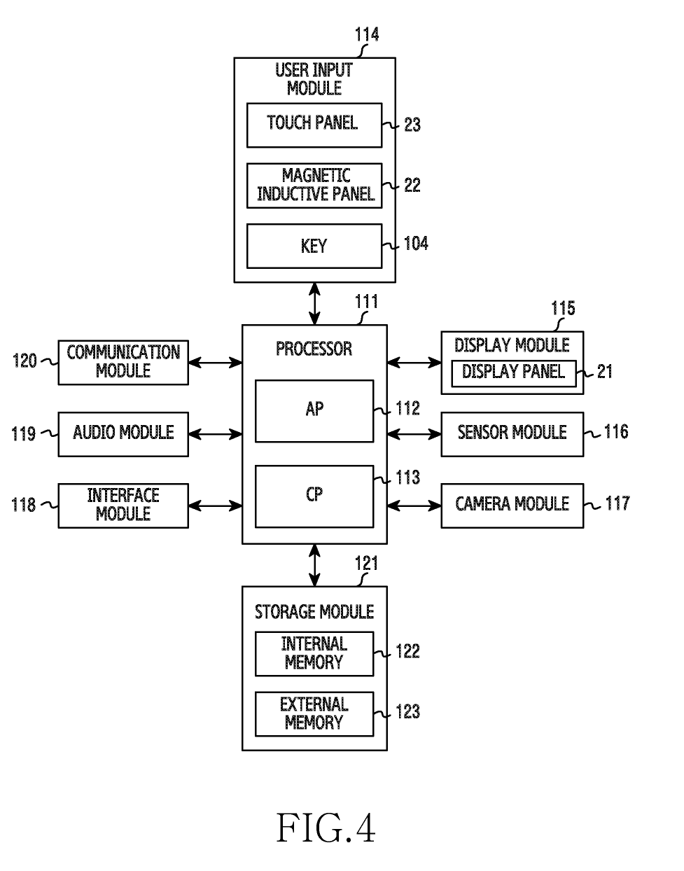

FIG. 4 is a block diagram of an electronic device according to an embodiment of the present invention.

Referring to FIG. 4, the electronic device 100 may include a user input module 114, a display module 115, a sensor module 116, a camera module 117, an interface module 118, an audio module 119, a communication module 120, a storage module 121, and at least one processor 111.

FIG. 4 merely illustrates an exemplary embodiment of an electronic device and therefore may include additional constituent units for other functions. According to an embodiment, the electronic device 100 may be implemented by incorporating at least two constituent units into one constituent unit or may be implemented by dividing one constituent unit into at least two constituent units.

According to various embodiments, the user input module 114 may receive various commands input from a user. According to an embodiment, the user input module 114 may include at least one of the touch panel 23, the magnetic inductive panel 22, and the key 104.

According to an embodiment, the touch panel 23 may include at least one of a capacitive type panel, a resistive type panel, an (ultra)sonic panel, and an optical (infrared) sensor type panel. According to an embodiment, the touch panel 23 may detect an input operation which directly touches the upper surface of the complex panel 20. According to an embodiment, the above-described touch panel (e.g.: a capacitive type panel, a (ultra)sonic type panel, and an optical (infrared) sensor type panel) may sense not only a touch by a direct touch but also an input (e.g.: hovering input) which senses an object when the object enters within a predetermined sensing distance before the touch is performed.

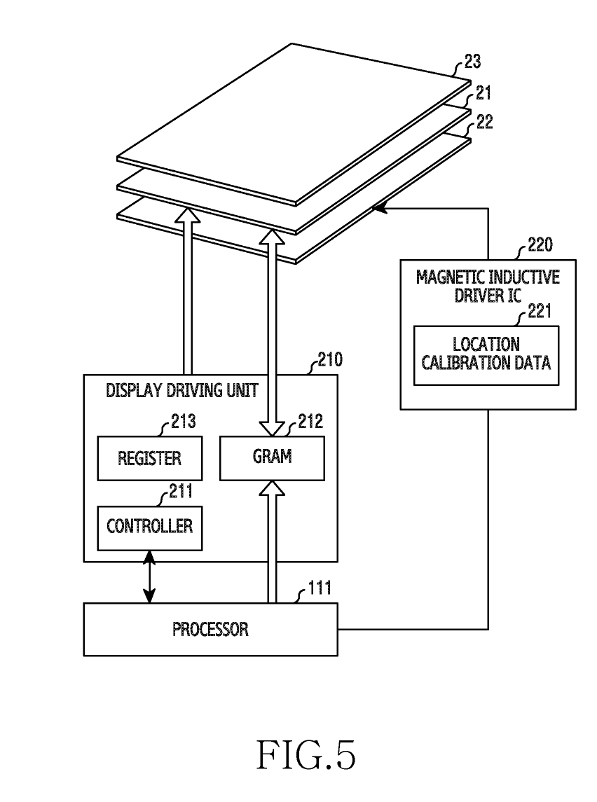

According to an embodiment, the magnetic inductive panel 22 may detect the entry of an object, i.e. the electronic pen 1, which has a magnetic body and a coil body in a magnetic field formed by an AC voltage applied to a plurality of coil arrays. According to an embodiment, the magnetic inductive panel 22 may also detect both a direct touch and an indirect touch (e.g.: hovering input). The magnetic inductive panel 22 may include a magnetic inductive driver IC (220 in FIG. 5) for controlling a detected location of the object, which enters the complex panel 20, and for providing a signal related to such a control to the processor of the electronic device 100. According to an embodiment, conceptually, the magnetic inductive driver IC 220 may also be electrically connected to but physically separated from the magnetic inductive panel 22.

According to an embodiment, the key 104 may include at least one physical key button that is disposed to be exposed in a proper position outside the electronic device 100. According to an embodiment, the key 104 may include at least one of a wake-up/sleep key button, a volume up/down button, a home button, and a key button for mode switching, which are arranged in outer proper positions.

According to various embodiments, the display module 115 may include the display panel 21. According to an embodiment, the display panel 21 may be, for example, a TFT-LCD panel for applying an electric field to a liquid crystal material, which has anisotropic permittivity and is injected between two substrates, and for adjusting the intensity of the electric field, thereby displaying an image with a desired shape and color. The display panel 21 may supply a screening control signal, which is supplied by the processor, to a screening line in a predetermined scanning period. According to an embodiment, the display module 115 (or processor) may include a display driving unit (e.g.: LCD driver IC (LDI) (210 in FIG. 5) for: receiving, from the processor, an input of a gradation data signal, a horizontal synchronization signal (Hsync) and a vertical synchronization signal (Vsync); sampling the input signal; and controlling a scanning driver and a data driver. According to an embodiment, the LDI 210 may be implemented integrally with the LCD panel 21. According to an embodiment, conceptually, the LDI 210 may also be electrically connected to but physically separated from the LCD panel 21.

According to various embodiments, the sensor module 116 may include at least one of a gesture sensor, a gyro sensor, a hall sensor, an acceleration sensor, a proximity sensor, a temperature sensor, a smell sensor, a fingerprint recognition sensor, an iris recognition sensor, and an illumination sensor.

According to various embodiments, the camera module 117 may perform a function of photographing still and moving images. According to an embodiment, the camera module 117 may be implemented to include one or more image sensors (e.g., front lens and rear lens), an image signal processor (ISP), or a flash LED.

According to various embodiments, the interface module 118 may be used for data transmission/reception to/from an external device. According to an embodiment, the interface module 118 may include at least one of a high-definition multimedia interface (HDMI), a universal serial bus (USB), a projector, and a D-subminiature (D-Sub). According to an embodiment, the interface module may further include a secure digital (SD)/multi-media card (MMC) or an infrared data association (IrDA).

According to various embodiments, the audio module 119 may convert a sound and an electrical signal in a bidirectional manner. The audio module 119 may conceptually include an audio codec and may convert input or output sound information by including at least one of a speaker, a receiver, earphones, and a microphone.

According to various embodiments, the communication module 120 may connect the electronic device 100 to an external device by using one antenna device or a plurality of antenna devices, depending on a control of the processor 111. According to an embodiment, the communication module 120 may include at least one of a mobile communication unit, a wireless Internet unit, a short range communication unit, and a location information unit. According to an embodiment, the communication module may include a network interface (e.g., LAN card) or modem for connecting the electronic device 100 to a network (e.g., Internet, local area network (LAN), wire area network (WAN), telecommunication network, cellular network, satellite network, or plain old telephone service (POTS).

According to various embodiments, the storage module 121 may include at least one of an internal memory 122 and an external memory 123. According to an embodiment, the storage module may store information on a scanning period of a predetermined range, which has been configured such that a noise generated from the LCD panel does not affect the magnetic inductive panel.

According to an embodiment, the internal memory 122 may include at least one of a volatile memory (e.g., dynamic RAM (DRAM), static RAM (SRAM), or synchronous dynamic RAM (SDRAM)), a non-volatile memory (e.g., one time programmable read-only memory (OTPROM), programmable ROM (PROM), erasable and programmable ROM (EPROM), electrically erasable and programmable ROM (EEPROM), mask ROM, or flash ROM), a hard disk drive (HDD), and a solid state drive (SSD). According to an embodiment, the processor 111 may load a command or data received from at least one of a non-volatile memory and other elements into a volatile memory and may process the loaded command or data. According to an embodiment, the processor 111 may store, in a non-volatile memory, data received from or generated by other elements.

According to an embodiment, the external memory 123 may, for example, include at least one of a compact flash (CF), a secure digital (SD), a micro secure digital (Micro-SD), a mini secure digital (Mini-SD), an extreme digital (xD), and a memory stick.

According to an embodiment, the storage module 121 may store an operating system for controlling resources of the electronic device 100 and an application program for an application operation. The operating system may include a kernel, middleware, an application program interface (API), and the like.

According to an embodiment, the kernel may include a system resource manager, which can manage resources, and a device driver. The resource manager may include, for example, a processor manager, a memory manager, or a file system manager and may perform a function of controlling, allocating, or withdrawing system resources. The device driver allows various elements to be controlled by a software approach. To this end, the device driver may be divided into an interface and individual driver modules provided by respective hardware manufacturers. The device driver may include at least one of a display driver, a camera driver, a Bluetooth driver, a shared memory driver, a USB driver, a keypad driver, a Wi-Fi driver, an audio driver, and an Inter-Process Communication (IPC) driver.

According to an embodiment, the middleware may be configured to include a plurality of modules which are pre-implemented to provide a function commonly required by various applications. The middleware may provide the commonly required functions through APIs such that the applications can efficiently use limited system resources within the electronic device. The middleware may include at least one of, for example, an application manager, a window manager, a multimedia manager, a resource manager, a power manager, a database manager, and a package manager. The middleware may include at least one of a connectivity manager, a notification manager, a location manager, a graphic manager, and a security manager according to an embodiment. Further, according to an embodiment, the middleware may include a runtime library or other library modules. The runtime library is a library module used by a compiler in order to add a new function through a programming language while an application is being executed. For example, the runtime library may perform a function related to an input/output, a memory management, or a calculation function. The middleware may create and use a new middleware module through various functional combinations of the aforementioned internal element modules. Meanwhile, the middleware may provide a specialized module according to the type of an operating system in order to provide a differentiated function.

According to an example, the API is a set of API programming functions and may be provided in different configurations according to an operating system. As an example, in the case of Android or iOS, for example, one API set may be provided for each platform. In the case of Tizen, for example, two or more API sets may be provided for each platform.

According to an embodiment, an application may perform at least one function by using an application program. The application may be divided into a preloaded application and a third party application. The application may include a home application for executing a home screen, a dialer application, a short message server (SMS)/multi-media message service (MMS) application, a messenger application such as Kakao-Talk or Chat-On, a browser application, a camera application, an alarm application, a contact (or address book) application, a voice dial application, an email application, a calendar application, a media player, an album application, a clock application, and the like.

According to various embodiments, the processor 111 may drive an operating system and an application program so as to control multiple hardware and software elements connected to the processor 111 and to perform processing of various data including multimedia data and a calculation. According to an embodiment, the processor 111 may provide a control signal (gradation data signal, vertical synchronization signal, and horizontal synchronization signal) based on an external input to the display driving unit of the display panel 21 and control the display panel to display the corresponding image. According to an embodiment, the processor 111 may detect a scanning period of the display panel 21 and may determine whether the detected scanning period is included within the range of a predetermined scanning period. According to an embodiment, when the determined scanning period does not exist within the predetermined range, the processor 111 may control the driving unit to adjust the internal operation clock or may control the magnetic inductive panel to perform location calibration.

According to various embodiments, the processor 111 may include at least one application processor (AP) 112 and/or at least one communication processor (CP) 113. According to an embodiment, although the AP 112 and the CP 113 are illustrated as being included in the processor, the configuration is not limited thereto and therefore the AP 112 and the CP 113 may be included in different IC packages, respectively. According to an embodiment, the AP 112 and the CP 113 may also be included in one IC package.

According to an embodiment, the AP 112 may drive an operation system or an application program so as to control multiple hardware or software elements connected to the AP 112 and to perform processing of various data including multimedia data and a calculation. According to an embodiment, the AP 112 may be implemented as a system on chip (SoC). According to an embodiment, the processor 111 may further include a graphic processing unit (GPU).

According to an embodiment, the CP 113 may perform a function of managing a data link and converting a communication protocol in communication between the electronic device 100 including the above hardware and other electronic devices connected to the electronic device 100 over a network. According to an embodiment, the CP 113 may be implemented as a SoC. According to an embodiment, the CP 113 may perform at least some multimedia controlling functions.

According to an embodiment, the AP 112 or the CP 113 may also load, into a volatile memory, a command or data received from at least one of a non-volatile memory and other elements, which are connected to each of the AP 112 and the CP 113, and then process the loaded command or data. According to an embodiment, the AP 112 or the CP 113 may also store data which is received from at least one of other elements or generated by at least one of other elements.

FIG. 5 is a configuration view of a display panel and a magnetic inductive panel according to an embodiment of the present invention.

Referring to FIG. 5, the LDI 210 for controlling the display panel 21 may include a controller 211 and a memory (GRAM) 212, and a register 213.

The controller 211 may control overall operations of the display panel 21. According to an embodiment, the controller 211 may control the brightness and resolution of the display panel 21. According to an embodiment, the controller 211 may receive a gradation data signal, a horizontal synchronization signal, and a vertical synchronization signal, which are provided from the processor, and provide the received signals to the LCD panel 21. According to an embodiment, the controller 211 may detect a current video mode on the basis of the horizontal synchronization signal and vertical synchronization signal applied from the processor 111 of the electronic device 100. According to an embodiment, the controller 211 may count a signal (e.g.: Tearing Effect (TE)) generated whenever the display panel 21 has completely read specified data among image data stored in the memory 212 in response to a request of the processor 111, calculate a scanning period on the basis of the count value, and provide the calculated scanning period to the processor 111. According to an embodiment, the controller 211 may control the register 213 to change an internal operation clock.

According to an embodiment, the memory 212 may include Graphic RAM (GRAM). According to an embodiment, the memory 212 may store raw image data provided from the processor 111 of the electronic device and may provide the stored raw image data to the display panel 21.

According to an embodiment, the register 213 may be controlled by the controller 211 to change the internal operation clock of the LCD panel 21. According to an embodiment, the register 213 may change a phase or frequency of a clock sampled in a process of converting an input analogue image signal into a digital signal through a non-illustrated analog/digital (AD) convertor.

According to various embodiments, the magnetic inductive driver IC 220 may detect an input location according to an input sensed by the magnetic inductive panel 22, and may provide information on the detected input location to the processor 111. According to an embodiment, the magnetic inductive driver IC 220 may include location calibration data 221. According to an embodiment, the magnetic inductive driver IC 220 may perform location calibration operation for an accurate input coordinate detection, periodically or whenever necessary by using the location calibration data 221.

According to various embodiments, the scanning period of the LCD panel 21 may be change while the LCD panel 21 is operated. According to an embodiment, when the LCD panel 21 is operated in a cmd mode, the scanning period may be changed according to a state (e.g.: temperature, humidity, brightness, shape, or voltage) of the display panel, and a signal (e.g.: noise) generated while the scanning period is changed may affect an operation of the magnetic inductive panel 22. In this case, the magnetic inductive panel 22 may not accurately detect the input location. According to an embodiment, the state of the display panel 21 may be changed on the basis of the storage speed in which the row image data provided from the processor 111 is stored in a memory of the LDI 210. The scanning period of the display panel 21 may also be changed on the basis of a change in the state of the display panel.

According to various embodiments of the present invention, the electronic device 100 may manipulate the internal operation clock of the LCD panel 21 in order to change the changed scanning period into an original scanning period, or may perform the location calibration of the magnetic inductive panel 22 so as to correspond to the changed scanning period.

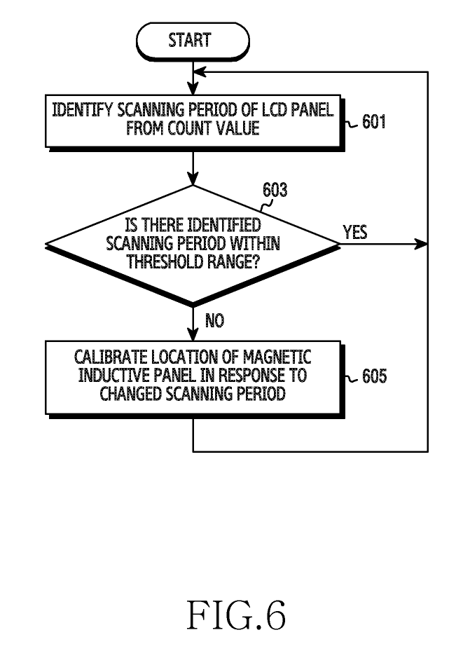

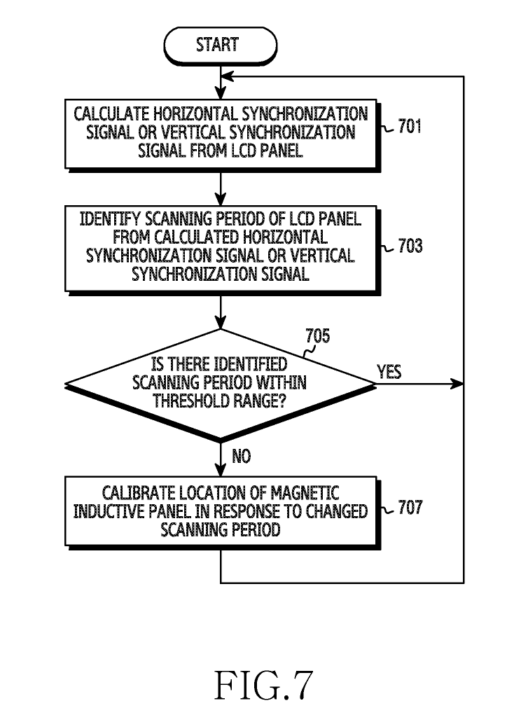

FIGS. 6 and 7 are flowcharts illustrating a process for calibrating a location of a magnetic inductive panel on the basis of an operation condition of a display panel (e.g.: LCD) according to various embodiments of the present invention.

Referring to FIG. 6, the electronic device may perform operation 601 for identifying the scanning period of a display panel. According to an embodiment, for example, the electronic device (e.g.: through the processor) may count the number of signals (e.g.: Tearing Effect (TE) signals) generated whenever the display panel has completely read specified data among image data stored in a memory, and may calculate the scanning period of the display panel on the basis of count information.

The electronic device may perform operation 603 for determining whether there is a scanning period within a predetermined threshold range. When there is no scanning period within the threshold range in operation 603, the electronic device may proceed to operation 605 and control, in response to the changed scanning period, a magnetic inductive driver IC of the magnetic inductive panel to perform location calibration. Additionally or alternatively, the electronic device may return to operation 601 to perform a feedback operation which repeats the above-described process. Additionally or alternatively, when there is a scanning period within the threshold range in operation 603, the electronic device may return to operation 601 to repeat the above-described operation.

An embodiment may provide an electronic device including: a display panel; at least one sensing panel; and at least one processor, which performs a control to identify the scanning period of the display panel, determine whether there is an identified scanning period within a threshold range, and perform location calibration of the sensing panel in response to the changed scanning period, when there is no scanning period within the threshold range.

Referring to FIG. 7, the electronic device may perform operation 701 for calculating a horizontal synchronization signal (or, vertical synchronization signal) and may perform operation 703 for identifying the scanning period of a display panel on the basis of the horizontal synchronization signal. The electronic device may receive, for example, a timing according to the horizontal synchronization signal or vertical synchronization signal provided from the display driving unit, may calculate the scanning period of the display panel on the base of the timing.

The electronic device may perform operation 705 for determining whether there is a scanning period within a predetermined threshold range. When there is no scanning period within the threshold range in operation 705, the electronic device may proceed to operation 707 and control, in response to the changed scanning period, the magnetic inductive driver IC of the magnetic inductive panel to perform location calibration. Additionally or alternatively, the electronic device may return to operation 701 to perform a feedback operation which repeats the above-described process. Additionally or alternatively, when there is a provided scanning period within the threshold range in operation 705, the electronic device may return to operation 701 to repeat the above-described process.

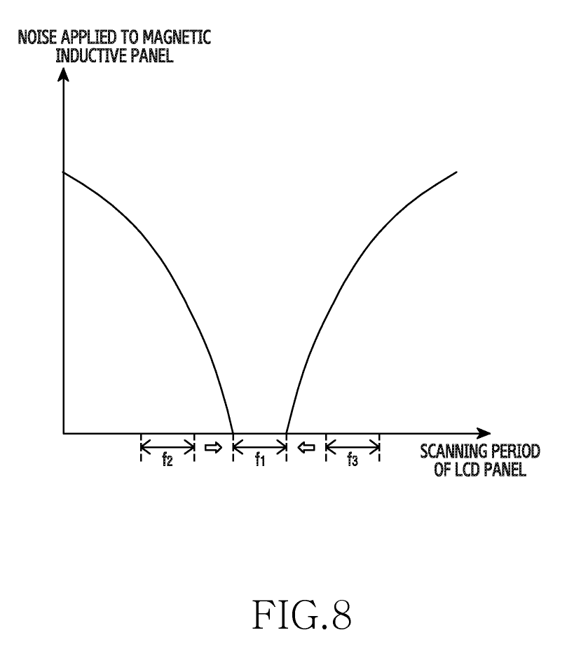

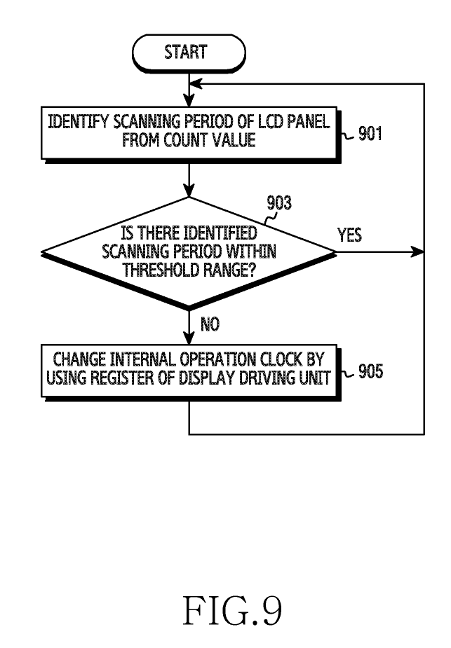

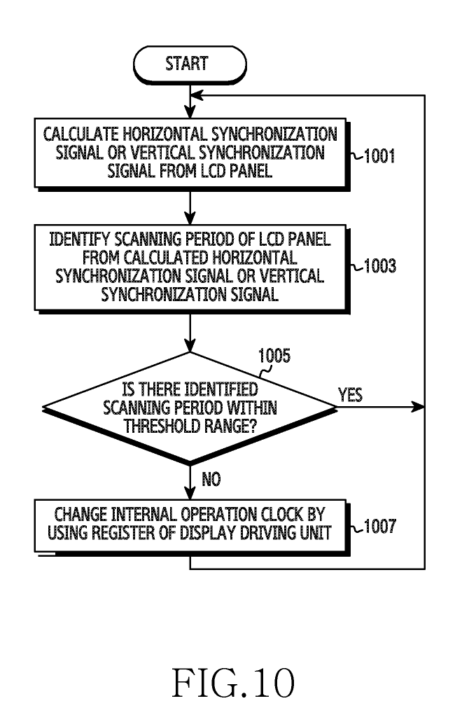

FIG. 8 is a graph illustrating a correlation with a scanning period of a display panel according to a signal (e.g.: noise) applied to a magnetic inductive panel according to an embodiment of the present invention. FIGS. 9 and 10 are flowcharts illustrating a process for changing an internal operation clock of a display panel on the basis of an operation condition of the display panel according to various embodiments of the present invention.

Referring to FIG. 9, the electronic device may perform operation 901 for identifying the scanning period of a display panel. According to an embodiment, for example, the electronic device (e.g.: through the processor) may count the number of signals (e.g.: Tearing Effect (TE) signals) generated whenever the display panel has completely read specified data among image data stored in a memory, and may calculate the scanning period of the display panel on the basis of count information.

The electronic device may perform operation 903 for determining whether there is the scanning period within a predetermined threshold range. When there is no scanning period within the threshold range in operation 903, the electronic device may proceed to operation 905 and may change an internal operation clock of the display panel through a register of the display driving unit. According to an embodiment, the scanning period may be changed into a desired scanning period by changing the internal operation clock. Thereafter, the electronic device may return to operation 901 to perform a feedback operation which repeats the above-described process.

Referring to FIG. 8, the magnetic inductive panel may be configured such that the minimum noise is applied at an interval f1 of the corresponding scanning period of the display panel. According to an embodiment, the scanning period of the display panel may be changed to f2 or f3 according to a state of the display panel (e.g.: a temperature change of the outside or a speed at which raw image data is stored in an LDI memory). In this case, a noise applied to the magnetic inductive panel is increased and thereby an input location may not be accurately detected. In operation 807, the electronic device may manipulate a register of the display driving unit so as to change an internal operation clock, thereby changing the scanning period from f2 or f3 to f1 and reducing noise induced to the magnetic inductive panel.

Referring to FIG. 10, the electronic device may perform operation 1001 for calculating a horizontal synchronization signal (or vertical synchronization signal) and may perform operation 1003 for identifying the scanning period of the display panel on the basis of the horizontal synchronization signal. The electronic device may, for example, receive timing according to the horizontal synchronization signal or vertical synchronization signal provided from the display driving unit and may calculate the scanning period of the display panel on the basis of the timing.

The electronic device may perform operation 1005 for determining whether there is a scanning period within a predetermined threshold range. When there is no scanning period within the threshold range in operation 1005, the electronic device may proceed to operation 1007 to change an internal operation clock of the display panel through a register of the display driving unit. According to an embodiment, the scanning period may be changed into a desired scanning period by changing the internal operation clock.

The electronic device may return to operation 1001 to perform a feedback operation which repeats the above-described process.

An embodiment may provide an electronic device including: a display panel; at least one sensing panel; and at least one processor, which performs a control to identify a scanning period of the display panel, determine whether there is an identified scanning period within a threshold range, and change an internal operation clock of the display panel when there is no scanning period within the threshold range.

Methods according to embodiments stated in the claims and/or specifications may be implemented by hardware, software, or a combination of hardware and software.

In the implementation of software, a computer-readable storage medium for storing one or more programs (software modules) may be provided. The one or more programs stored in the computer-readable storage medium may be configured for execution by one or more processors within the electronic device. The one or more programs may include instructions for allowing the electronic device to perform methods according to embodiments stated in the claims and/or specifications of the present invention.

The programs (software modules or software) may be stored in non-volatile memories including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or other type optical storage devices, or a magnetic cassette. Alternatively, any combination of some or all of the may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. The storage device may access the electronic device through an external port.

Further, a separate storage device on a communication network may access a portable electronic device.

It will be apparent to those skilled in the art that various modifications and changes falling within the scope of the appended claims may be made in these embodiments. In other words, the embodiments may be implemented in a very variety of ways without departing from the spirit and scope of the present invention as defined by the appended claims.

1. A method for operating a complex panel, the method comprising:
identifying a scanning period of a display panel; and
calibrating a sensing panel by using first location calibration information when the identified scanning period belongs to a first range, and calibrating the sensing panel by using second location calibration information when the scanning period belongs to a second range.

2. The method of claim 1, wherein, in the identifying of the scanning period of the display panel, the scanning period is calculated on the basis of a count value of a signal generated whenever the display panel has completely read image data stored in a memory of a display driving unit.

3. The method of claim 1, wherein, in the identifying of the scanning period of the display panel, the scanning period is calculated on the basis of timing of a horizontal or vertical synchronization signal provided to an LDI.

4. The method of claim 1, wherein the sensing panel comprises at least one of a capacitive type panel, a resistive type panel, a (ultra)sonic type panel, an optical (infrared) sensor type panel, and an magnetic induction-type panel.

5. The method of claim 1, wherein the sensing panel may detect a location by directly touching the complex panel, detect the location without a touch within a predetermined sensing distance, or perform both operations.

6. An electronic device, comprising:
a display panel;
at least one sensing panel; and
at least one processor configured to perform a control to: identify a scanning period of the display panel, calibrate the sensing panel by using first location calibration information when the identified scanning period belongs to a first range, and calibrate the sensing panel by using second location calibration information when the scanning period belongs to a second range.

7. The electronic device of claim 6, wherein the processor performs a control so that the scanning period is calculated on the basis of a count value of a signal generated whenever the display panel has completely read image data stored in a memory of a display driving unit.

8. The electronic device of claim 6, wherein the processor performs a control so that the scanning period is calculated on the basis of a horizontal synchronization signal or a vertical synchronization signal provided to the display driving unit.

9. The electronic device of claim 6, wherein the sensing panel comprises at least one of a capacitive type panel, a resistive type panel, a (ultra)sonic type panel, an optical (infrared) sensor type panel, and an magnetic induction-type panel.

10. A method for operating a complex panel comprising a display panel and at least one sensing panel, the method comprising:
identifying a scanning period of the display panel;
determining whether the identified scanning period exists within a threshold range; and
changing an internal operation clock of the display panel when the scanning period does not exist within the threshold range.

11. The method of claim 10, wherein, in the changing of the internal operation clock, a change is performed such that the scanning period is included in the threshold range.

12. The method of claim 10, wherein, in the identifying of the scanning period of the display panel, the scanning period is calculated on the basis of a count value of a signal generated whenever the display panel has completely read image data stored in a memory of a display driving unit.

13. The method of claim 10, wherein, in the identifying of the scanning period of the display panel, the scanning period is calculated on the basis of a horizontal synchronization signal or a vertical synchronization signal provided to the display driving unit.

14. The method of claim 10, wherein the sensing panel may detect a location by directly touching the complex panel, detect the location without a touch within a predetermined sensing distance, or perform both operations.

15. An electronic device comprising:
a display panel;
at least one sensing panel; and
at least one processor configured to perform a control to: identify a scanning period of the display panel, determine whether the identified scanning period exists within a threshold range, and change an internal operation clock of the display panel when the identified scanning period does not exist within the threshold range.
